(19) United States
(12) Patent Application Publication
(10) Pub. No.: US 2026/0178418 A1
(43) Pub. Date: Jun. 25, 2026

(54) DATA LOCALITY-AWARE LOAD BALANCING

(71) Applicant: Dell Products L.P., Round Rock, TX (US)

(72) Inventors: Mikhail Borisov, Dublin (IE); Kalyan C. Gunda, Shrewsbury, MA (US); Karthik Prabakaran, Bangalore (IN)

(21) Appl. No.: 18/987,499

(22) Filed: Dec. 19, 2024

(51) Int. Cl. G06F 9/50

(52) U.S. Cl. CPC G06F 9/5083; G06F 9/5033; G06F 9/5044

(57) ABSTRACT

Data locality-aware load balancing (e.g., using a computerized tool), is enabled. For example, a system can comprise at least one processor, and at least one memory that stores executable instructions that, when executed by the at least one processor, facilitate performance of operations. The operations can comprise, in response to receiving a request associated with an object, determining, using a data locality cache, a node in an object storage in which the object is stored, and in response to determining the node, establishing a communicative connection between a client device associated with the request and the node.

### BACKGROUND

An object store can store data and metadata in chunks, which are logical containers of data. Chunks can comprise full copy or erasure-coded segments. Segments can be spread across nodes, for instance, to achieve high availability and fault tolerance requirements.

When a request is processed by a load balancer, the load balancer conventionally applies a standard load balancing policy, such as round robin. Without knowledge about data storage locations, the request can be sent to a node that does not have the requested data stored locally. This first receiving node will then forward the request to another node with the data associated with the request available. As a result, due to the additional network hop, conventional load balancer performance is slow and inefficient.

The above-described background relating to load balancing is merely intended to provide a contextual overview of some current issues and is not intended to be exhaustive. Other contextual information may become further apparent upon review of the following detailed description.

### BRIEF DESCRIPTION OF DRAWINGS

FIG. 1 is a block diagram of an example system in accordance with one or more example embodiments described herein.

FIG. 2 is a block diagram of example computer executable components in accordance with one or more example embodiments described herein.

FIG. 3 is a block diagram of an example data locality cache in accordance with one or more example embodiments described herein.

FIG. 4 is a block diagram of an example capacity cache in accordance with one or more example embodiments described herein.

FIG. 5 is a flow diagram for a process associated with data locality-aware load balancing in accordance with one or more example embodiments described herein.

FIG. 6 is a flow diagram for a process associated with data locality-aware load balancing in accordance with one or more example embodiments described herein.

FIG. 7 is a flow diagram for a process associated with data locality-aware load balancing in accordance with one or more example embodiments described herein.

FIG. 8 is a flow diagram for a process associated with data locality-aware load balancing in accordance with one or more example embodiments described herein.

FIG. 9 is an example, non-limiting computing environment in which one or more embodiments described herein can be implemented.

FIG. 10 is an example, non-limiting networking environment in which one or more embodiments described herein can be implemented.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

As alluded to above, load balancing can be improved in various ways, and various example embodiments are described herein to this end and/or other ends.

According to an example embodiment, a system can comprise at least one processor, and at least one memory that stores executable instructions that, when executed by the processor, facilitate performance of operations, comprising, in response to receiving a request associated with an object, determining, using a data locality cache, a node in an object storage in which the object is stored, and in response to determining the node, establishing a communicative connection between a client device associated with the request and the node.

In one or more example embodiments, the node can comprise a first node. In this regard, the object can be determined to be stored in the first node and a second node in the object storage, and the first node can be selected in response to a determination that the first node comprises a lower utilization according to a defined utilization metric. Further in this regard, the defined utilization metric can be based on respective central processing unit usage or respective memory usage of the first node and the second node.

In one or more example embodiments, the object can be distributed as segments across a group of nodes of the object storage, comprising the node. In this regard, the data locality cache can store only a first segment location of the object. Further in this regard, the object can be distributed as segments across the group of nodes in response to a determination that the object satisfies a defined object size threshold.

In one or more example embodiments, the above operations can further comprise, in response to a determination that a location of the object is not stored in the data locality cache, selecting a node in the object storage, wherein selecting the node comprises initiating a forward read request, and updating the data locality cache based on the location of the object.

In one or more example embodiments, the above operations can further comprise, in response to establishing a communicative connection between the client device and the node, updating the data locality cache based on a location of the object.

In one or more example embodiments, caching of objects in the data locality cache can be limited based on at least one of user account data representative of a user account associated with the object, bucket name data representative of a bucket name associated with the object, or object tag data representative of an object tag associated with the object.

In one or more example embodiments, the above operations can further comprise, in response to a determination that a location of the object has changed, updating the data locality cache based on the location of the object.

In one or more example embodiments, the above operations can further comprise, in response to a determination that the node comprises a data failure applicable to the object, updating the data locality cache based on the data failure.

In one or more example embodiments, the request can comprise a data read request.

In one or more example embodiments, the data locality cache can comprise a least recently used type data locality cache.

In another example embodiment, a non-transitory machine-readable medium can comprise executable instructions that, when executed by a processor, facilitate performance of operations, comprising, in response to receiving a write request associated with an object, determining, using a capacity cache, a location in an object store at which to store the object, and in response to determining the location of the object, establishing a communicative connection between a client device associated with the request and the location.

In one or more example embodiments, the above operations can further comprise, in response to a determination that a data write applicable to the write request was successful, updating a data locality cache based on the location of the object.

In one or more example embodiments, the location can comprise a server in the object store.

In one or more example embodiments, the location can be determined to have available capacity to store the object.

In one or more example embodiments, the above operations can further comprise, in response to a determination that the object satisfies a defined object size threshold, dividing the object across different segments to be stored across different locations in the object store, respectively storing the different segments across the different locations, and updating a locality cache with a location of only a first segment of the different segments, wherein locations of other segments of the different segments, other than the first segment, are not stored in the locality cache.

In yet another example embodiment, a method can comprise, in response to receiving a request associated with an object and using a data locality cache, determining, by a load balancer comprising at least one processor, a server in an object storage via which the object is stored, and in response to determining the server, facilitating, by the load balancer, establishing a communicative connection between a client device associated with the request and the server.

In one or more example embodiments, the load balancer can comprise a multiplexing load balancer.

In one or more example embodiments, the above method can further comprise, in response to data being stored to the server, updating, by the load balancer, a capacity cache applicable to the server.

In various example embodiments, an object store herein can provide organizations with the ability to store, manage, and/or access unstructured data at a scale comparable to public cloud services, but with the reliability and control of a private cloud infrastructure.

An object store herein can store data and metadata in chunks, which can comprise logical containers of data (e.g., 128 MB or other suitable sizes). Chunks herein can comprise, for instance, full copy or erasure-coded segments. Segments herein can be spread across nodes, for instance, to achieve high availability and fault tolerance requirements.

Load balancers can distribute network or application traffic across several servers (e.g., nodes). The load balancers distribute the traffic, for instance, to ensure no single server bears too much demand. By balancing the requests, for instance, load balancers help improve responsiveness and increase the availability of applications or websites for users.

On an open systems interconnection (OSI) model, a load balancer can comprise (1) a network load balancer (NLB), which can operate at the transport layer (e.g., layer 4) and can be designed for handling high volumes of transmission control protocol (TCP) traffic with low latency, and/or (2) an application load balancer (ALB), which is suitable for hypertext transfer protocol/hypertext transfer protocol secure (HTTP/HTTPS) traffic (e.g., layer 7) and can route requests based on uniform resource locator (URL) paths, hostnames, and/or other HTTP headers.

Load balancers ensure, for instance, increased availability, performance, scalability, and/or resilience in object storage systems. In various example embodiments, load balancers described herein can comprise ALBs capable of handling defined amazon web services (AWS) S3 object protocols.

In various example embodiments, ALBs described herein can support connection multiplexing. Connection multiplexing enables the ALB to decouple the client TCP and HTTP connection from the server-side TCP and HTTP connection. The foregoing enables, for instance, load balancing and distribution of HTTP requests across nodes using any open server-side connections. Without multiplexing, request distribution from traffic (e.g., originating from one client connection) arrives at one server (e.g., node). With multiplexing, request distribution from traffic (e.g., originating from one client connection) arrives at multiple servers (e.g., nodes). When multiple clients (e.g., multiple client connections) utilize multiplexing, requests are eligible for load balancing across any server (e.g., node) of the corresponding object store.

Example embodiments herein enable load balancing, for instance, based on data locality awareness. In combination with connection multiplexing and statistics exposed by object stores herein, an ALB herein is enabled to forward requests to nodes with the data stored and/or capacity locally available, thus increasing overall system performance. For instance, the ALB can utilize data locality metrics to forward requests to nodes on which the data is stored locally. The foregoing minimizes additional network hops, thereby improving read performance.

Example embodiments herein enable optimized read and write flows. For read requests, an ALB herein can check its corresponding cache for data locality information and forward the request to the appropriate node of a corresponding object store. If the data is not found locally (e.g., the location was not described in the cache), the cache can be updated (e.g., via the ALB) with the new (e.g., correct) location. For write requests, the ALB can additionally, or alternatively, utilize capacity information to select the best node for storing new data while updating the cache(s) accordingly.

Example embodiments herein enable data locality metrics collection, which exposes APIs to an ALB, for instance, to provide up-to-date information about location(s) of object(s) herein. Example embodiment herein can expose APIs, for instance, to provide up-to-date information about the location of objects, which the ALB can store in a least recently used (LRU) cache. The foregoing ensures, for instance, that the most relevant data locality information is readily available.

Additionally, example embodiments herein enable data locality cache management, which enables an ALB to store metrics in a cache. Additionally, example embodiments herein enable an optimized read flow, in which an ALB can send requests to a node with data available locally and update cache information, as applicable. Further, example embodiments herein enable an optimized write flow, in which an ALB can send write/update requests to a node with capacity available locally and update cache information, as applicable.

In various example embodiments described herein, an ALB herein can be exposed to various data locality metrics. For instance, for read operations, an object URI to node identifier (ID)—internet protocol (IP) mapping (e.g., bucket1/object1→Node X) is available to an ALB herein. For write/update operations, a list of the nodes with sufficient free capacity to store a local chunk's segments is available to an ALB herein. In various example embodiments, an ALB herein can obtain object location information from an object store:
(1) In response to write/update requests,
(2) Through metrics channel (e.g., event based) when an object location is changed,
   (a) Full copy chunk is sealed, converted to erasure-coded chunk. Segments are redistributed,
   (b) As a result of disk or node failure (e.g., data recovery),
   (c) Horizontal capacity expansion (e.g., node or rack addition)—data redistribution,
(3) In response to a read request when data is not found locally on the requested node,
   (a) ALB cache miss or outdated entry.
      In this regard, an ALB described herein can minimize the probability of an additional network hop between nodes herein to retrieve the requested data.

Example embodiments herein further optimize handling of large objects (e.g., objects greater than or equal to a defined object size threshold). For large objects that are distributed across multiple nodes in an object store, an ALB herein can store (e.g., in a corresponding data locality cache) information about only the first segment's location, for instance, to improve performance and minimize cache size. In this regard, the first segment itself can point to the second segment, the second segment can point to the third segment, and so on, so that additional segment locations (e.g., other than the first segment location) do not need to be stored in the data locality cache.

Example embodiments herein further enable data movement handling. For example, a data location can be changed, for instance, due to erasure coding, smart data rebalancing algorithms, and/or disk and node failures, among other reasons. In this regard, example embodiments herein enable maintenance of up-to-date data location information for an ALB.

Example embodiments herein facilitate enhanced performance and scalability. In this regard, by reducing unnecessary network hops and optimizing the distribution of read and write requests, the embodiments described herein realize increased overall system performance and scalability.

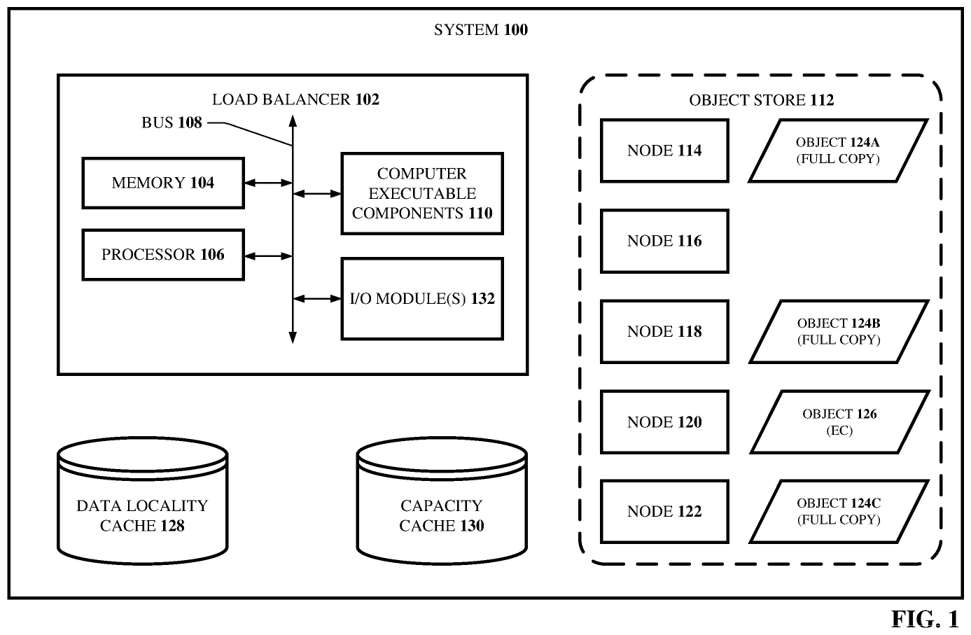

Turning now to FIG. 1, there is illustrated an example, non-limiting system 100 in accordance with one or more example embodiments herein. System 100 can comprise a computerized tool, which can be configured to perform various operations relating to data locality-aware load balancing. The system 100 can comprise one or more of a variety of components, such as load balancer 102 (e.g., a multiplexing ALB) (e.g., comprising memory 104, processor 106, bus 108, input/output (I/O) module(s) 132, and/or computer executable components 110), object store 112 (e.g., comprising node 114, node 116, node 118, node 120, node 122, object 124A, object 124B, object 124C, and/or object 126), data locality cache 128, and/or capacity cache 130. In various example embodiments, one or more of the load balancer 102, object store 112, data locality cache 128, and/or capacity cache 130 can be communicatively or operably coupled (e.g., over a bus or wireless network) to one another to perform one or more functions of the system 100.

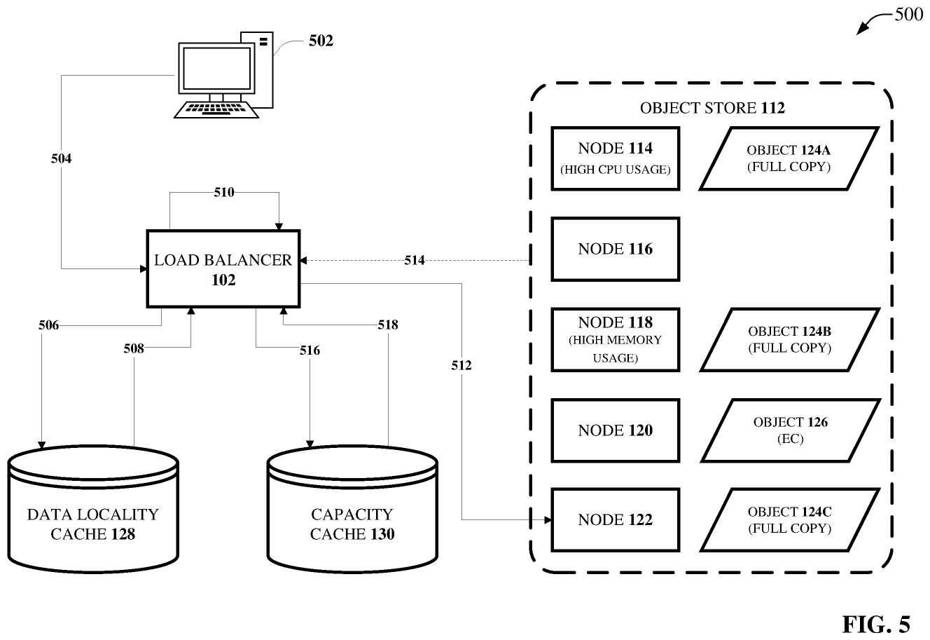

In various embodiments, the system 100 can further comprise and/or be communicatively coupled to a client device (see, e.g., client device 502 of FIG. 5). Such a client device (e.g., client device 502) can comprise, for instance, desktop computers, laptops, tablets, smartphones, servers, information of things (IoT) devices, virtual machines, containers, network appliances, dedicated backup appliances, or other suitable client devices.

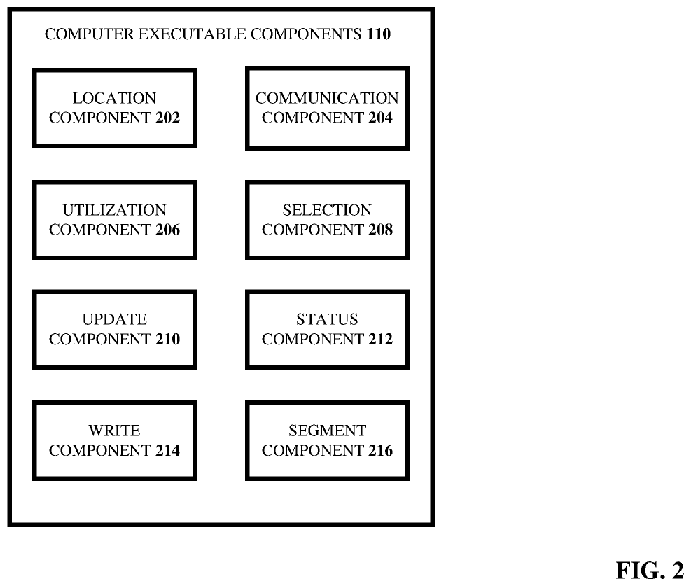

FIG. 2 illustrates a block diagram of example, non-limiting computer executable components 110 that can facilitate data locality-aware load balancing in accordance with one or more embodiments described herein. As shown in FIG. 2, the one or more computer executable components 110 can comprise the location component 202, communication component 204, utilization component 206, selection component 208, update component 210, status component 212, write component 214, and/or segment component 216. It is noted that while various components described herein can perform one or more corresponding functions, processes, or actions, the computer executable components 110 as a whole and/or the processor 106 can be configured to perform one or more of the described functions, processor, or actions.

In one or more example embodiments, the location component 202 can, in response to receiving (e.g., via a client device 502) a request (e.g., a read request or a write request) associated with an object (e.g., an object 124), determine (e.g., using the data locality cache 128) a node (e.g., node 114, node 118, and/or node 122) in an object store 112 in which the object (e.g., object 124) is stored. In one or more example embodiments, the data locality cache 128 can comprise an LRU type data locality cache. In this regard, old data can be removed (e.g., via the load balancer 102) from the data locality cache 128 once cache capacity of the data locality cache 128 is reached. The foregoing ensures, for instance, that the most relevant data locality information is readily available. In various example embodiments, caching of objects herein in the data locality cache 128 can be limited (e.g., via the load balancer 102) based on user account data representative of a user account associated with the object (e.g., object 124), bucket name data representative of a bucket name associated with the object (e.g., object 124), and/or object tag data representative of an object tag associated with the object (e.g., object 124).

In one or more example embodiments, the communication component 204 can, in response to determining (e.g., via the location component 202) the node (e.g., node 114, node 118, and/or node 122), establish a communicative connection (e.g., via the I/O module(s) 132) between a client device (e.g., client device 502) associated with the request and the node (e.g., node 114, node 118, and/or node 122). In this regard, when the client device (e.g., client device 502) sends the request to the object store 112, the load balancer 102 acts as an intermediary, evaluating the request (e.g., from the client device 502) and distributing it to an appropriate node (e.g., node 114, node 118, and/or node 122) within the object store 112. In various example embodiments, the I/O modules 132 can comprise and/or interface with a network card.

In various example embodiments, the node can comprise a first node (e.g., node 122), and the object can be determined to be stored in the first node (e.g., node 122) and a second node (e.g., node 114 or node 118) in the object store 112. In this regard, the first node (e.g., node 122) can be selected (e.g., via the communication component 204) in response to a determination (e.g., via the utilization component 206) that the first node (e.g., node 122) comprises a lower utilization according to a defined utilization metric. For instance, the defined utilization metric can be based on respective central processing unit usage (CPU) or respective memory usage of the first node and the second node. In this regard, when more than one node (e.g., node 114, node 118, and/or node 122) comprises the object (e.g., object 124), the communication component 204 can consider one or more of a variety of factors (e.g., memory usage, CPU usage, or other suitable factors) among the nodes (e.g., node 114, node 118, and/or node 122) comprising the object (e.g., object 124) and select a node (e.g., node 114, node 118, and/or node 122) determined to optimize system 100 performance. For instance, the communication component 204 can select a node (e.g., node 114, node 118, and/or node 122) comprising the lowest memory usage, lowest CPU usage, or according to another suitable mode of node selection.

In various example embodiments, the object (e.g., object 124) can be distributed as segments across a group of nodes (e.g., comprising the node) of the object store 112. In this regard, the data locality cache 128 can store only a first segment location of the object. By storing (e.g., via the update component 210) the first segment location only in the data locality cache 128, rather than all segment locations, the system 100 comprises improved performance and minimize cache size. In this regard, the first segment itself can point to the second segment, the second segment can point to the third segment, and so on, so that additional segment locations (e.g., other than the first segment location) do not need to be stored in the data locality cache 128. Further in this regard, the object can be distributed as segments across the group of nodes in response to a determination (e.g., via the status component 212) that the object satisfies a defined object size threshold.

In one or more example embodiments, the selection component 208 can, in response to a determination that a location of the object (e.g., object 124) is not stored in the data locality cache 128, select a node (e.g., node 114, node 116, node 118, node 120, or node 122) in the object store 112. In some example embodiments, selecting (e.g., via the selection component 208) the node (e.g., node 114, node 116, node 118, node 120, or node 122) can comprise initiating a forward read request. In this regard, with respect to a forward read request, a receiving node can identify that it does not hold the requested object (e.g., via metadata or by consulting a defined distributed index). The receiving node can then forward the request to the correct node (e.g., based on routing or metadata management logic), thus ensuring that the client device (e.g., client device 502) receives the requested data, for instance, without needing to resend the request. The update component 210 can then update the data locality cache 128 based on the actual location of the object (e.g., the node that the request from the client device was ultimately forwarded to by the receiving node).

In one or more example embodiments, the update component 210 can, in response to establishing (e.g., via the communication component 204) a communicative connection between the client device (e.g., client device 502) and the node (e.g., node 114, node 116, node 118, node 120, or node 122), update the data locality cache 128, for instance, based on a location (e.g., confirmed node location) of the object (e.g., object 124 or object 126). In further embodiments, location component 202 can determine that a location (e.g., confirmed node location) of the object (e.g., object 124 or object 126) has changed. In this regard, the update component 210 can update the data locality cache 128 based on the location (e.g., confirmed node location) of the object (e.g., object 124 or object 126). Such a location of the object (e.g., object 124 or object 126) can change, for instance, based on load balancing, data sharding, node failure or maintenance, cluster scaling, data tiering, or for other suitable reasons. In this regard, in one or more example embodiments, the update component 210 can, in response to a determination (e.g., via the status component 212) that the node (e.g., node 114, node 116, node 118, node 120, or node 122) comprises a data failure applicable to the object (e.g., object 124 or object 126), update the data locality cache 128 based on the data failure. For example, if a given object is stored on multiple nodes, and one of those nodes is determined (e.g., via the status component 212) to have failed, such a location entry can be removed (e.g., via the update component 210) from the data locality cache 128.

In one or more example embodiments, the location component 202 can, in response to receiving (e.g., from a client device 502) (e.g., via the communication component 204) a write request associated with an object (e.g., object 124 or object 126), determine (e.g., using a capacity cache 130), a location (e.g., a server or node) (e.g., node 114, node 116, node 118, node 120, or node 122) in an object store 112 at which to store the object (e.g., object 124 or object 126). In this regard, the communication component 204, can in response to determining (e.g., via the location component 202) the location of the object (e.g., object 124 or object 126), establish a communicative connection between a client device (e.g., client device 502) associated with the request and the location (e.g., node 114, node 116, node 118, node 120, or node 122).

In one or more example embodiments, the update component 210 can, in response to a determination that a data write (e.g., via the write component 214) applicable to the above write request was successful (e.g., no determined errors), update the data locality cache 128, for instance, based on the location of the object (e.g., object 124 or object 126). In this regard, the location can be determined (e.g., via the status component 212) to have available capacity to store the object (e.g., by utilizing the capacity cache 130).

In one or more example embodiments, the segment component 216 can, in response to a determination (e.g., via the status component 212) that an object (e.g., object 124 or object 126) satisfies a defined object size threshold, divide the object across different segments to be stored across different locations (e.g., node 114, node 116, node 118, node 120, and/or node 122) in the object store 112. In this regard, the write component 214 can respectively store the different segments across the different locations (e.g., node 114, node 116, node 118, node 120, and/or node 122). Further in this regard, the update component 210 can update the data locality cache 128, for instance, with a location (e.g., node or server in the object store 112) of only a first segment of the different segments, in which locations of other segments of the different segments, other than the first segment, are not stored in the data locality cache 128. The foregoing can, for instance, improve performance and minimize data locality cache 128 utilization. In this regard, the first segment itself can point to the second segment, the second segment can point to the third segment, and so on, so that additional segment locations (e.g., other than the first segment location) do not need to be stored in the data locality cache 128.

In one or more example embodiments, the update component 210 can, in response to data being stored to the server, update a capacity cache 130 applicable to the location (e.g., server or node). In various example embodiments, the capacity cache 130 can store various capacity data of respective nodes locations (e.g., node 114, node 116, node 118, node 120, and/or node 122) herein. For instance, the capacity cache 130 can store remaining capacity, storage used, storage capacity, or other suitable capacity information applicable to nodes locations (e.g., node 114, node 116, node 118, node 120, and/or node 122) herein.

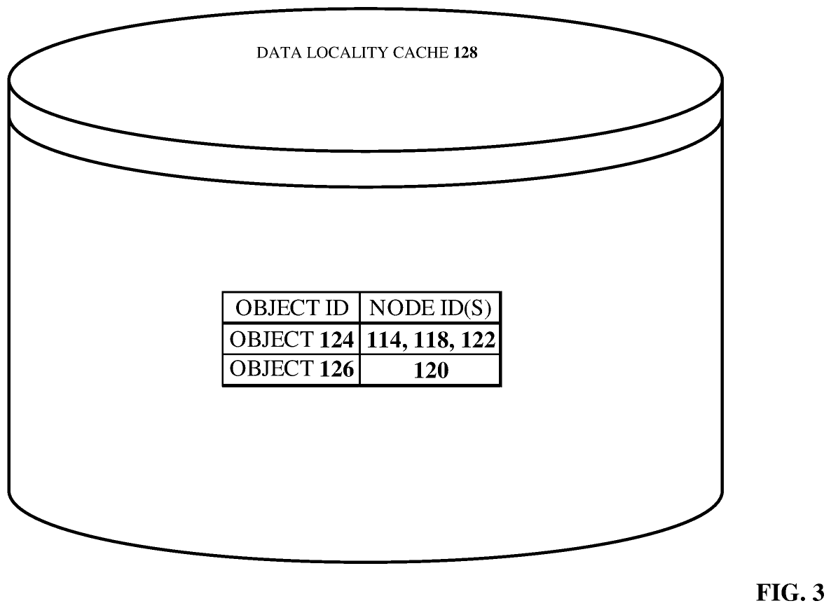

FIG. 3 is a block diagram of an example data locality cache 128 in accordance with one or more example embodiments described herein. In various example embodiments, the data locality cache 128 can store and/or can comprise one or more of a variety of data types. For instance, the data locality cache 128 can store object identifiers (IDs) of one or more objects (e.g., object 124 and/or object 126) stored in the object store 112, and corresponding node IDs of nodes (e.g., servers, locations, etc.) on which respective objects are stored. For example, in FIG. 3, object 124 (e.g., a full copy object) is stored on nodes 114, 118, and 122, while object 126 (e.g., an erasure coded object) is stored on node 120. Further, in some embodiments, the data locality cache 128 can be configured (e.g., via the load balancer 102) based on user account data representative of a user account associated with the object (e.g., object 124 and/or object 126), bucket name data representative of a bucket name associated with the object (e.g., object 124 and/or object 126), and/or object tag data representative of an object tag associated with the object (e.g., object 124 and/or object 126). In this regard, caching of objects in the data locality cache 128 can be limited (e.g., via the load balancer 102) based on user account data representative of a user account associated with the object (e.g., object 124 and/or object 126), bucket name data representative of a bucket name associated with the object (e.g., object 124 and/or object 126), and/or object tag data representative of an object tag associated with the object (e.g., object 124 and/or object 126). For example, that load balancer 102 can limit caching of objects to objects that comprise and/or are associated with one or more defined user accounts, bucket names, and/or object tags. In various example embodiments, the load balancer 102 can store corresponding node metrics in LRU cache (e.g., the data locality cache 128). In this regard, old data can be removed from the data locality cache 128 once cache capacity of the data locality cache 128 is reached.

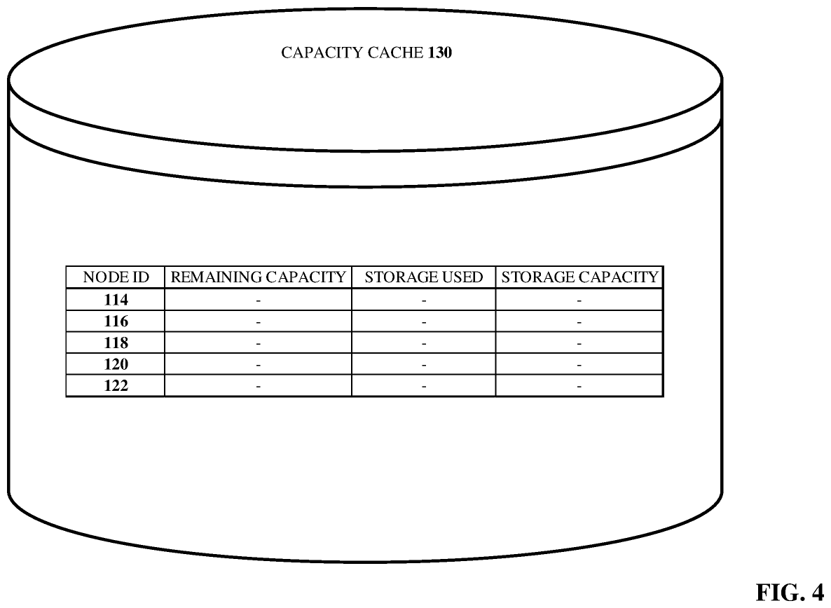

FIG. 4 is a block diagram of an example capacity cache 130 in accordance with one or more example embodiments described herein. In various example embodiments, the capacity cache 130 can store (e.g., via the load balancer 102) (e.g., via the status component 212 and/or via the update component 210) various capacity data of respective nodes (e.g., node 114, node 116, node 118, node 120, and/or node 122) herein. For instance, the capacity cache 130 can store remaining capacity, storage used, storage capacity, or other suitable capacity information applicable to nodes (e.g., node 114, node 116, node 118, node 120, and/or node 122) herein.

FIG. 5 is a flow diagram for a process 500 associated with data locality-aware load balancing in accordance with one or more example embodiments described herein. At 504, a request (e.g., a read request or a write request) can be transmitted from the client device 502 to the load balancer 102. At 506, the load balancer 102 can scan the data locality cache 128 in order to determine nodes (e.g., node 114, node 118, and node 122) that comprise an object (e.g., object 124) associated with the request and return that node information (e.g., which nodes comprise the object 124) at 508. At 510, any other suitable load balancing policies (e.g., round robin, least connections, least response time, weighted round robin, weighted least connections, IP hash, random, geometric load balancing, dynamic load balancing, priority-based load balancing, or other suitable load balancing policies) can be applied. In this regard, if the load balancer 102 determines that data (e.g., an object) associated with the request is available on multiple nodes, such other load balancing policies can be applied. For example, if the load balancer 102 determines that data (e.g., an object) associated with the request is available on multiple nodes, the load balancer 102 can select the node based on node CPU usage and/or node memory usage (e.g., the load balancer 102 can select the node with the lowest CPU usage and/or lowest memory usage). At 512, the node 122 can be selected by the load balancer 102. The load balancer 102 can select node 122, for instance, because node 114 comprises high CPU usage and node 118 comprises high memory usage (e.g., relative to node 114). Such CPU, memory usage information, and/or capacity information can be available to the load balancer 102, for instance, via the metrics channel 514. At 516, CPU, memory usage information, and/or capacity information can be stored to the capacity cache 130, for instance (e.g., for retrieval at 518).

Objects herein can be determined (e.g., via the status component 212) to be small or large, for instance, depending on whether the object (e.g., object 124 or object 126) is less than or equal to a defined threshold size. For example, such a nonlimiting example size can comprise less than or equal to 10.6 megabytes (MB) for a 12+4 erasure coded schema. In this regard, a small object is not split into slices. The load balancer 102 can, upon receiving a read request (e.g., from a client device 502), determine a cache hit or a cache miss (e.g., from the data locality cache 128). A cache hit is determined (e.g., via the load balancer 102), for instance, if nodes herein, for the requested object, are found in the data locality cache 128. When requested object is available from several nodes, additional load balancing policies can be applied (e.g., if configured) (e.g., round robin, least connections, least response time, weighted round robin, weighted least connections, IP hash, random, geometric load balancing, dynamic load balancing, priority-based load balancing, or other suitable load balancing policies). In various example embodiments, the load balancer 102 can (1) check node availability and/or resources utilization, (2) select a node and forward the request, and (3) update the data locality cache 128 entry, for instance, if the object location change is indicated in response. When requested object is available from single node only, the load balancer 102 can (1) forward read request to that node, and (2) update the data locality cache 128 entry, for instance, if the object location change is indicated in response. A cache miss is determined (e.g., via the load balancer 102), for instance, if nodes for a requested object are not found in the data locality cache 128. The load balancer 102 can apply, for instance, additional load balancing policies (e.g., if configured) (e.g., round robin, least connections, least response time, weighted round robin, weighted least connections, IP hash, random, geometric load balancing, dynamic load balancing, priority-based load balancing, or other suitable load balancing policies). In various example embodiments, the load balancer 102 can (1) pick the node and forward read request, and (2) update cache entry (a) if object not found on the node new location information is indicated in response, or (b) data is available on the picked node. For a large object (e.g., greater than or equal to a defined threshold size) (e.g., 10.6 MB for 12+4 erasure coded schema), the object can be distributed across multiple nodes. In this regard, to improve performance and minimize data locality cache 128 utilization, the load balancer 102 can store information about first segment location and forward the read request to that node (e.g., first block of the data can be returned to the client without waiting for all blocks to be retrieved from the object store 112). In this regard, the first segment itself can point to the second segment, the second segment can point to the third segment, and so on, so that additional segment locations (e.g., other than the first segment location) do not need to be stored in the data locality cache. For a write request, the load balancer 102 can (1) check capacity cache 130, (2) apply other load balancing policies (e.g., if configured) (e.g., round robin, least connections, least response time, weighted round robin, weighted least connections, IP hash, random, geometric load balancing, dynamic load balancing, priority-based load balancing, or other suitable load balancing policies), (3) select the node and send the request, and (4) update the data locality cache 128 upon a successful response.

Utilizing various example embodiments described herein, performance increases can vary based on one or more of a variety of factors. Such factors can comprise, for instance, object size, operation type (e.g., read/write/update), load balancer 102 CPU and/or memory size (e.g., data locality cache 128 size), speed of frontend/backend network, speed of disks (e.g., of nodes) utilized herein, and/or other suitable factors. Considering, for instance, overhead of 4 k object round-trip time (RTT) on 25 Gbps network vs 4 k object read time from nonvolatile memory express (NVMe) disks, (1) RTT range is 1-2 milliseconds, and (2) NVMe read time range is 10-100 microseconds. In this regard, RTT overhead can be significant in certain scenarios.

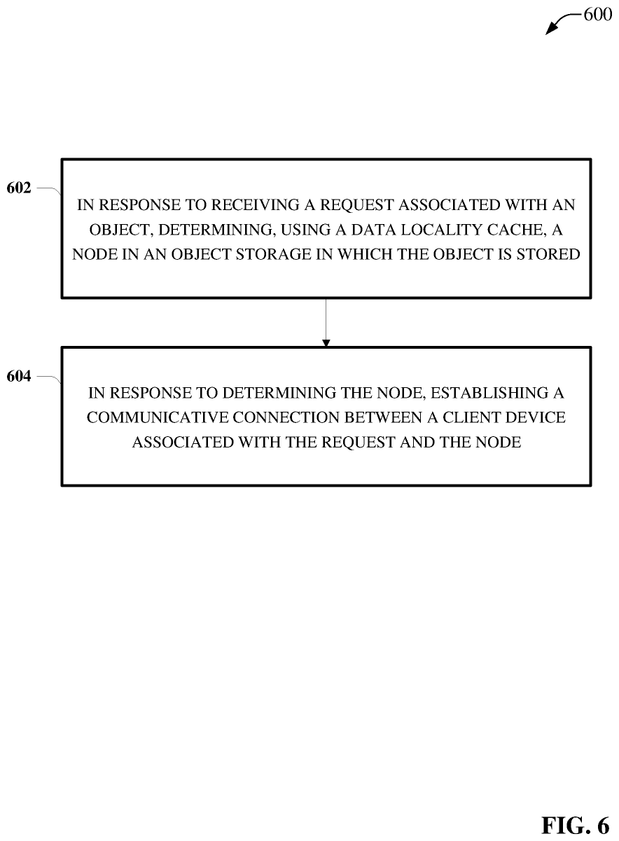

FIG. 6 is a flow diagram for a process 600 associated with data locality-aware load balancing in accordance with one or more example embodiments described herein. At 602, the process 600 can comprise, in response to receiving a request associated with an object (e.g., object 124), determining (e.g., via the location component 202), using a data locality cache (e.g., data locality cache 128), a node (e.g., node 114, node 118, or node 122) in an object storage (e.g., object store 112) in which the object (e.g., object 124) is stored. At 604, the process 600 can comprise, in response to determining the node (e.g., node 114, node 118, or node 122), establishing (e.g., via the communication component 204) a communicative connection between a client device (e.g., client device 502) associated with the request and the node (e.g., node 114, node 118, or node 122).

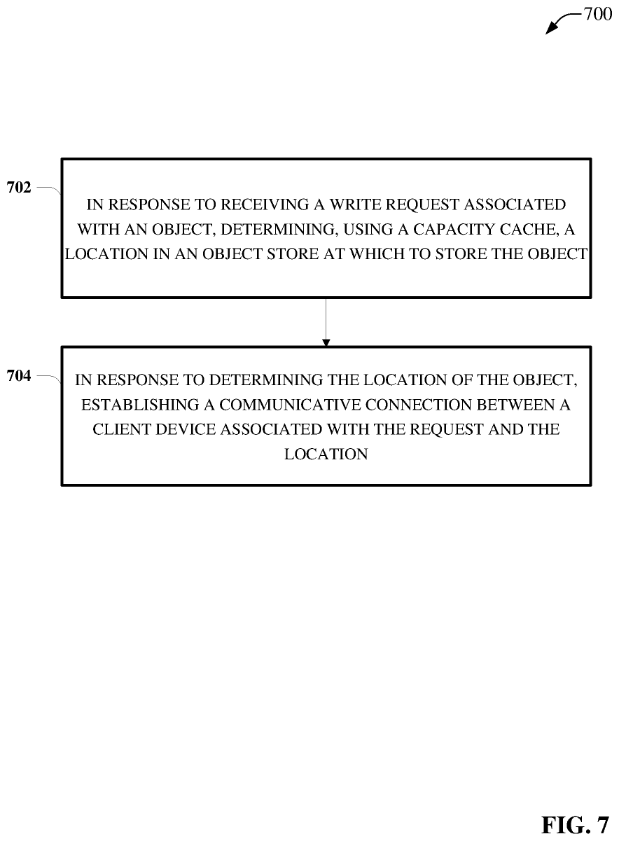

FIG. 7 is a flow diagram for a process 700 associated with data locality-aware load balancing in accordance with one or more example embodiments described herein. At 702, the process 700 can comprise in response to receiving a write request associated with an object (e.g., object 124), determining (e.g., via the location component 202), using a capacity cache (e.g., capacity cache 130), a location (e.g., node 114, node 118, or node 122) in an object store (e.g., object store 112) at which to store the object (e.g., object 124). At 704, the process 700 can comprise, in response to determining the location of the object (e.g., object 124), establishing (e.g., via the communication component 204) a communicative connection between a client device (e.g., client device 502) associated with the request and the location (e.g., node 114, node 118, or node 122).

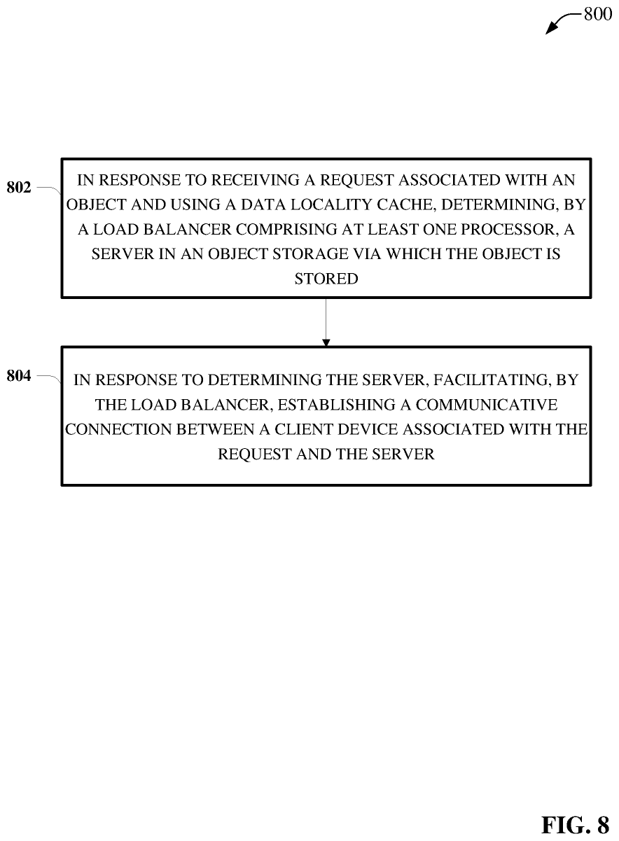

FIG. 8 is a flow diagram for a process 800 associated with data locality-aware load balancing in accordance with one or more example embodiments described herein. At 802, the process 800 can comprise, in response to receiving a request associated with an object (e.g., object 124) and using a data locality cache (e.g., data locality cache 128), determining (e.g., via the location component 202), by a load balancer (e.g., load balancer 102) comprising at least one processor (e.g., processor 106), a server (e.g., node 114, node 118, or node 122) in an object storage (e.g., object store 112) via which the object (e.g., object 124) is stored. At 804, the process 800 can comprise, in response to determining the server (e.g., node 114, node 118, or node 122), facilitating (e.g., via the communication component 204), by the load balancer (e.g., load balancer 102), establishing a communicative connection between a client device (e.g., client device 502) associated with the request and the server (e.g., node 114, node 118, or node 122).

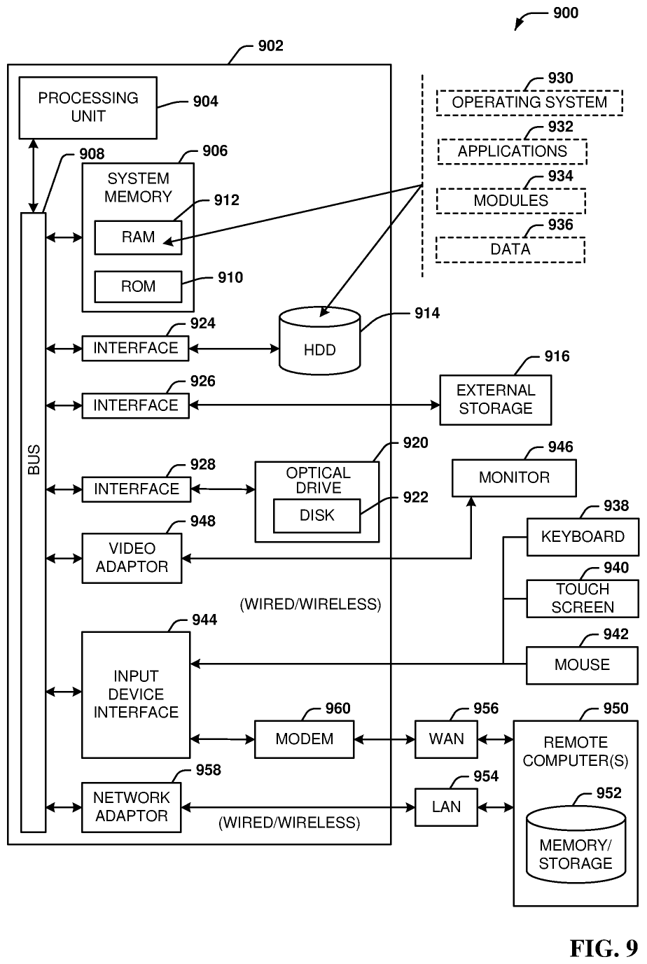

In order to provide additional context for various example embodiments described herein, FIG. 9 and the following discussion are intended to provide a brief, general description of a suitable computing environment 900 in which the various example embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, modules, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and include any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared, and other wireless media.

With reference again to FIG. 9, the example environment 900 for implementing various example embodiments of the aspects described herein includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 includes ROM 910 and RAM 912. A basic input/output system (BIOS) can be stored in a non-volatile memory such as ROM, erasable programmable read only memory (EPROM), EEPROM, which BIOS contains the basic routines that help to transfer information between elements within the computer 902, such as during startup. The RAM 912 can also include a high-speed RAM such as static RAM for caching data.

The computer 902 further includes an internal hard disk drive (HDD) 914 (e.g., EIDE, SATA), one or more external storage devices 916 (e.g., a magnetic floppy disk drive (FDD) 916, a memory stick or flash drive reader, a memory card reader, etc.) and an optical disk drive 920 (e.g., which can read or write from a disk 922, such as a CD-ROM disc, a DVD, a BD, etc.). While the internal HDD 914 is illustrated as located within the computer 902, the internal HDD 914 can also be configured for external use in a suitable chassis (not shown). Additionally, while not shown in environment 900, a solid-state drive (SSD) could be used in addition to, or in place of, an HDD 914. The HDD 914, external storage device(s) 916 and optical disk drive 920 can be connected to the system bus 908 by an HDD interface 924, an external storage interface 926 and an optical drive interface 928, respectively. The interface 924 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 902, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 912, including an operating system 930, one or more application programs 932, other program modules 934 and program data 936. All or portions of the operating system, applications, modules, and/or data can also be cached in the RAM 912. The systems and methods described herein can be implemented utilizing various commercially available operating systems or combinations of operating systems.

Computer 902 can optionally comprise emulation technologies. For example, a hypervisor (not shown) or other intermediary can emulate a hardware environment for operating system 930, and the emulated hardware can optionally be different from the hardware illustrated in FIG. 9. In such an example embodiment, operating system 930 can comprise one virtual machine (VM) of multiple VMs hosted at computer 902. Furthermore, operating system 930 can provide runtime environments, such as the Java runtime environment or the .NET framework, for applications 932. Runtime environments are consistent execution environments that allow applications 932 to run on any operating system that includes the runtime environment. Similarly, operating system 930 can support containers, and applications 932 can be in the form of containers, which are lightweight, standalone, executable packages of software that include, e.g., code, runtime, system tools, system libraries and settings for an application.

Further, computer 902 can be enabled with a security module, such as a trusted processing module (TPM). For instance, with a TPM, boot components hash next in time boot components, and wait for a match of results to secured values, before loading a next boot component. This process can take place at any layer in the code execution stack of computer 902, e.g., applied at the application execution level or at the operating system (OS) kernel level, thereby enabling security at any level of code execution.

A user can enter commands and information into the computer 902 through one or more wired/wireless input devices, e.g., a keyboard 938, a touch screen 940, and a pointing device, such as a mouse 942. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 904 through an input device interface 944 that can be coupled to the system bus 908, but can be connected by other interfaces, such as a parallel port, an IEEE 1394 serial port, a game port, a USB port, an IR interface, a BLUETOOTH® interface, etc.

A monitor 946 or another type of display device can also be connected to the system bus 908 via an interface, such as a video adapter 948. In addition to the monitor 946, a computer typically includes other peripheral output devices (not shown), such as speakers, printers, etc.

The computer 902 can operate in a networked environment using logical connections via wired and/or wireless communications to one or more remote computers, such as a remote computer(s) 950. The remote computer(s) 950 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 952 is illustrated. The logical connections depicted include wired/wireless connectivity to a local area network (LAN) 954 and/or larger networks, e.g., a wide area network (WAN) 956. Such LAN and WAN networking environments are commonplace in offices and companies, and facilitate enterprise-wide computer networks, such as intranets, all of which can connect to a global communications network, e.g., the Internet.

When used in a LAN networking environment, the computer 902 can be connected to the local network 954 through a wired and/or wireless communication network interface or adapter 958. The adapter 958 can facilitate wired or wireless communication to the LAN 954, which can also include a wireless access point (AP) disposed thereon for communicating with the adapter 958 in a wireless mode.

When used in a WAN networking environment, the computer 902 can include a modem 960 or can be connected to a communications server on the WAN 956 via other means for establishing communications over the WAN 956, such as by way of the Internet. The modem 960, which can be internal or external and a wired or wireless device, can be connected to the system bus 908 via the input device interface 944. In a networked environment, program modules depicted relative to the computer 902 or portions thereof, can be stored in the remote memory/storage device 952. It will be appreciated that the network connections shown are examples and other means of establishing a communications link between the computers can be used.

When used in either a LAN or WAN networking environment, the computer 902 can access cloud storage systems or other network-based storage systems in addition to, or in place of, external storage devices 916 as described above. Generally, a connection between the computer 902 and a cloud storage system can be established over a LAN 954 or WAN 956 e.g., by the adapter 958 or modem 960, respectively. Upon connecting the computer 902 to an associated cloud storage system, the external storage interface 926 can, with the aid of the adapter 958 and/or modem 960, manage storage provided by the cloud storage system as it would other types of external storage. For instance, the external storage interface 926 can be configured to provide access to cloud storage sources as if those sources were physically connected to the computer 902.

The computer 902 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

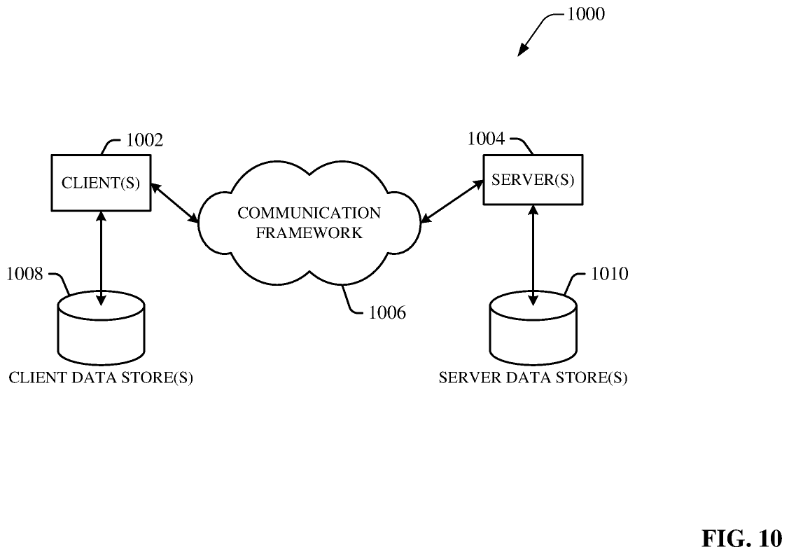

Referring now to FIG. 10, there is illustrated a schematic block diagram of a computing environment 1000 in accordance with this specification. The system 1000 includes one or more client(s) 1002, (e.g., computers, smart phones, tablets, cameras, PDA's). The client(s) 1002 can be hardware and/or software (e.g., threads, processes, computing devices). The client(s) 1002 can house cookie(s) and/or associated contextual information by employing the specification, for example.

The system 1000 also includes one or more server(s) 1004. The server(s) 1004 can also be hardware or hardware in combination with software (e.g., threads, processes, computing devices). The servers 1004 can house threads to perform transformations of media items by employing aspects of this disclosure, for example. One possible communication between a client 1002 and a server 1004 can be in the form of a data packet adapted to be transmitted between two or more computer processes wherein data packets may include coded analyzed headspaces and/or input. The data packet can include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

In one exemplary implementation, a client 1002 can transfer an encoded file, (e.g., encoded media item), to server 1004. Server 1004 can store the file, decode the file, or transmit the file to another client 1002. It is noted that a client 1002 can also transfer uncompressed files to a server 1004 and server 1004 can compress the file and/or transform the file in accordance with this disclosure. Likewise, server 1004 can encode information and transmit the information via communication framework 1006 to one or more clients 1002.

The illustrated aspects of the disclosure may also be practiced in distributed computing environments where certain tasks are performed by remote processing devices that are linked through a communications network. In a distributed computing environment, program modules can be located in both local and remote memory storage devices.

The above description includes non-limiting examples of the various example embodiments. It is, of course, not possible to describe every conceivable combination of components, modules, or methods for purposes of describing the disclosed subject matter, and one skilled in the art may recognize that further combinations and permutations of the various example embodiments are possible. The disclosed subject matter is intended to embrace all such alterations, modifications, and variations that fall within the spirit and scope of the appended claims.

With regard to the various functions performed by the above-described components, modules, devices, circuits, systems, etc., the terms (including a reference to a “means”) used to describe such components or modules are intended to also include, unless otherwise indicated, any structure(s) which performs the specified function of the described component or module (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various example embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
at least one processor; and
at least one memory that stores executable instructions that, when executed by the at least one processor, facilitate performance of operations, comprising:
in response to receiving a request associated with an object, determining, using a data locality cache, a node in an object storage in which the object is stored; and
in response to determining the node, establishing a communicative connection between a client device associated with the request and the node.

2. The system of claim 1, wherein the node comprises a first node, wherein the object is determined to be stored in the first node and a second node in the object storage, and wherein the first node is selected in response to a determination that the first node comprises a lower utilization according to a defined utilization metric.

3. The system of claim 2, wherein the defined utilization metric is based on respective central processing unit usage or respective memory usage of the first node and the second node.

4. The system of claim 1, wherein the object has been distributed as segments across a group of nodes of the object storage, comprising the node, and wherein the data locality cache stores only a first segment location of the object.

5. The system of claim 4, wherein the object has been distributed as segments across the group of nodes in response to a determination that the object satisfies a defined object size threshold.

6. The system of claim 1, wherein the operations further comprise:
in response to a determination that a location of the object is not stored in the data locality cache, selecting a node in the object storage, wherein selecting the node comprises initiating a forward read request; and
updating the data locality cache based on the location of the object.

7. The system of claim 1, wherein the operations further comprise:
in response to establishing a communicative connection between the client device and the node, updating the data locality cache based on a location of the object.

8. The system of claim 1, wherein caching of objects in the data locality cache are limited based on at least one of:
user account data representative of a user account associated with the object,
bucket name data representative of a bucket name associated with the object, or
object tag data representative of an object tag associated with the object.

9. The system of claim 1, wherein the operations further comprise:
in response to a determination that a location of the object has changed, updating the data locality cache based on the location of the object.

10. The system of claim 1, wherein the operations further comprise:
in response to a determination that the node comprises a data failure applicable to the object, updating the data locality cache based on the data failure.

11. The system of claim 1, wherein the request comprises a data read request.

12. The system of claim 1, wherein the data locality cache comprises a least recently used type data locality cache.

13. A non-transitory machine-readable medium, comprising executable instructions that, when executed by at least one processor, facilitate performance of operations, comprising:
in response to receiving a write request associated with an object, determining, using a capacity cache, a location in an object store at which to store the object; and
in response to determining the location of the object, establishing a communicative connection between a client device associated with the request and the location.

14. The non-transitory machine-readable medium of claim 13, wherein the operations further comprise:
in response to a determination that a data write applicable to the write request was successful, updating a data locality cache based on the location of the object.

15. The non-transitory machine-readable medium of claim 13, wherein the location comprises a server in the object store.

16. The non-transitory machine-readable medium of claim 13, wherein the location is determined to have available capacity to store the object.

17. The non-transitory machine-readable medium of claim 13, wherein the operations further comprise:
in response to a determination that the object satisfies a defined object size threshold, dividing the object across different segments to be stored across different locations in the object store;
respectively storing the different segments across the different locations; and
updating a locality cache with a location of only a first segment of the different segments, wherein locations of other segments of the different segments, other than the first segment, are not stored in the locality cache.

18. A method, comprising:
in response to receiving a request associated with an object and using a data locality cache, determining, by a load balancer comprising at least one processor, a server in an object storage via which the object is stored; and
in response to determining the server, facilitating, by the load balancer, establishing a communicative connection between a client device associated with the request and the server.

19. The method of claim 18, wherein the load balancer comprises a multiplexing load balancer.

20. The method of claim 18, further comprising:
in response to data being stored to the server, updating, by the load balancer, a capacity cache applicable to the server.
